(19) United States
(12) Patent Application Publication
(10) Pub. No.: US 2007/0208922 A1
(43) Pub. Date: Sep. 6, 2007

(54) Information processing apparatus

(75) Inventor: Takashi Abe, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 11/712,889

(22) Filed: Mar. 2, 2007

(30) Foreign Application Priority Data
Mar. 3, 2006 (JP) 2006-057103

(51) Int. Cl. G06F 15/00

(52) U.S. Cl. 712/1

(57) ABSTRACT

An information processing apparatus includes: a device group including a device which processes information and a device which stores information; and a switch which is connectable to a plurality of devices selected from the device group, and which allows information to be exchanged between devices connected to the switch.

### BACKGROUND OF THE INVENTION

1. Field of the Invention

The present invention relates to an information processing apparatus connectable to a plurality of devices.

2. Description of the Related Art

An information processing apparatus used for a server, a personal computer and the like includes devices such as a central processing unit (CPU), a memory, a hard disk drive (HDD) and a Peripheral Component Interconnect (PCI) slot (PCI is a trademark registered in the U.S.A.). Certain types of devices are attachable to and detachable from a main body of an information processing apparatus. The types and number of devices which can be connected to each information processing apparatus are set with respect to each information processing apparatus. A redesign of an apparatus is necessary in order to change the types and number of the connectable devices (for example, to decrease the number of memories, and to increase the number of HDDs). A wide variety of specifications are demanded for an information processing apparatus. In design, it is necessary to prepare various types of apparatuses for the purpose of satisfying all the demands.

Japanese Patent Application Publication No. 2001-318901 discloses a duplex multiprocessor system including a cross bar switch. The cross bar switch is connected to a processor card and two I/O device cards. A processor is mounted on the processor card. An I/O device connected to a file system is mounted on one of the processor cards, and an I/O device connected to a line interface is mounted on the other processor card. It is possible to change the numbers of processor cards and I/O device cards relatively freely. However, it is difficult to increase the number of main memories without increasing the number of processors, since a main memory is included in each processor.

In general, a memory, a HDD and a PCI slot use different types of interfaces, respectively. Accordingly, the types and number of the connectable devices should be set when a decision is made on the specifications of an apparatus. Once the types and number of the connectable devices are set, it is difficult to change the setting. In other words, it is difficult to expand a range of choices to choose devices. In addition, in a case where another specification other than predetermined specifications is demanded, another apparatus should be prepared.

### SUMMARY OF THE INVENTION

An object of the present invention is to provide an information processing apparatus achieving a wide range of choices to choose devices.

An information processing apparatus according to an aspect of the present invention includes: a device group including a device which processes information and a device which stores information; and a switch which is connectable to a plurality of devices selected from the device group, and which allows information to be exchanged between devices connected to the switch.

According to the information processing apparatus, it is possible to freely change the connectable types and number of devices.

### BRIEF DESCRIPTION OF THE DRAWINGS

FIG. 1 is a block diagram of an example of an information processing apparatus according to an exemplary embodiment;

FIG. 2 is a block diagram of another example of the information processing apparatus according to the exemplary embodiment;

FIG. 3 is a block diagram of a main controller; and

FIG. 4 is a perspective view of the information processing apparatus according to the exemplary embodiment.

### DESCRIPTION OF THE EXEMPLARY EMBODIMENT

An information processing apparatus of an exemplary embodiment is applied to a multi-slot server. The information processing apparatus includes a device group, a main body and a switch. The device group includes a device which processes information and a device which stores information. The switch is provided to the main body, and is connectable to a plurality of devices selected from the device group. The switch has a function of allowing information to be exchanged between the devices connected to the switch. The devices included in the device group are attachable to and detachable from the main body. It is possible to select a desired device among the device group, and then to attach the selected device to the main body. In the exemplary embodiment, the device group consists of the device which processes information, the device which stores information, and a device which inputs and outputs information from and to the outside.

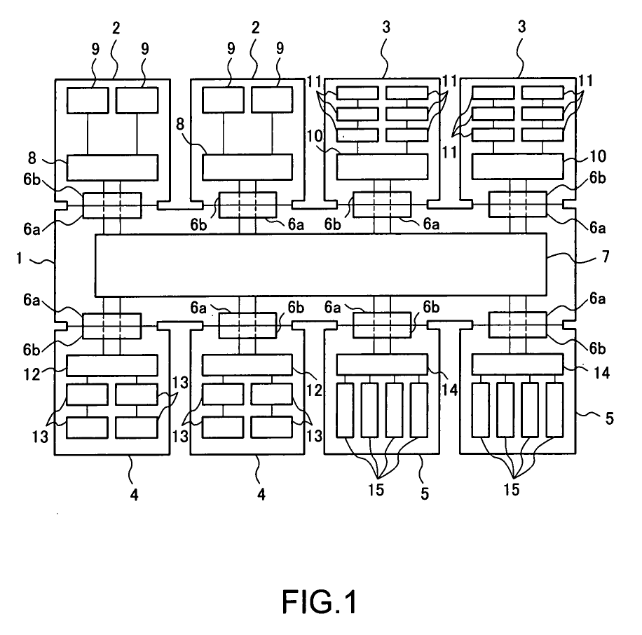

FIG. 1 shows elements mounted on a main board 1, two additional CPU boards 2, two memory boards 3, two HDD boards 4 and two PCI boards 5. The main board 1 is included in the main body. Each of the boards 2, 3, 4 and 5 is connected to the main board 1 through a switch side connector 6a and a device side connector 6b. The main board 1 is provided with eight switch side connectors 6a. Each of the boards 2, 3, 4 and 5 is provided with one device side connector 6b. Each of the device side connectors 6b of the boards 2, 3, 4 and 5 is connectable to any one of the switch side connectors 6a.

A main controller 7 including the switch, which will be described later, is mounted on the main board 1. CPUs 9 and a buffer circuit 8 for CPUs 9 are mounted on each of the CPU boards 2. Memory modules 11 including random access memories (RAMs) and a buffer circuit 10 for memory modules 11 are mounted on each of the memory boards 3. HDDs 13 and a buffer circuit 12 for HDDs 13 are mounted on each of the HDD boards 4. PCI-Express connectors 15 and a buffer circuit 14 for connectors 15 are mounted on each of the PCI boards 5 (PCI-Express is a trademark registered in the U.S.A.).

The foregoing device group includes the CPUs 9, the memory modules 11, the HDDs 13 and the PCI Express connectors 15. Each of the CPUs 9 is included in the foregoing device which processes information. Each of the memory modules 11 and the HDDs 13 is included in the foregoing device which stores information. Each of the connectors 15 is included in the device which inputs and outputs information from and to the outside. The device group may further include other types of devices.

The information processing apparatus includes switch side interfaces which are connected to the switch and are provided to the main body as well as device side interfaces which are respectively connected to devices included in the device group. The information processing apparatus of the exemplary embodiment includes the eight switch side interfaces. One device side interface is provided to each board on which the respective device is mounted (hereinafter, such a board is referred to as “device-mounted board”).

Each of the switch side interfaces includes one switch side connector 6a. Each of the device side interfaces includes one device side connector 6b and one of buffer circuits 8, 10, 12 and 14. Each of the device side interfaces is connectable to any one of the switch side interfaces. The switch side interface and the device side interface which are connected to each other transmit information between the switch of the main controller 7 and the device connected to the connected device side interface.

Recently, interfaces supporting serial high-speed transmission have been beginning to come into use for a CPU, a memory, a HDD, a PCI slot and the like. The interfaces employed for these devices are different from one another. The voltage level of the transmitted signal, the frequency thereof, the bit width and the like are fixed specifically for each of the interfaces. However, since their transmission methods are not different largely from one another, it is possible to make each of the interfaces connectable to any one of the switch side interfaces.

The main controller 7 is electrically connected to the devices 9, 11, 13 and 15 through the buffer circuits 8, 10, 12 and 14. Information transmitted in the information processing apparatus is transmitted in a serial transmission. FIG. 1 shows eight pairs of lines which include eight lines each transmitting information in a direction from the main controller 7 to each of the main switch side connectors 6a as well as eight lines each transmitting information in the opposite direction. In FIG. 1, the bit width is not taken into consideration, and a power supply wiring, a wiring for a control signal, and the like are omitted.

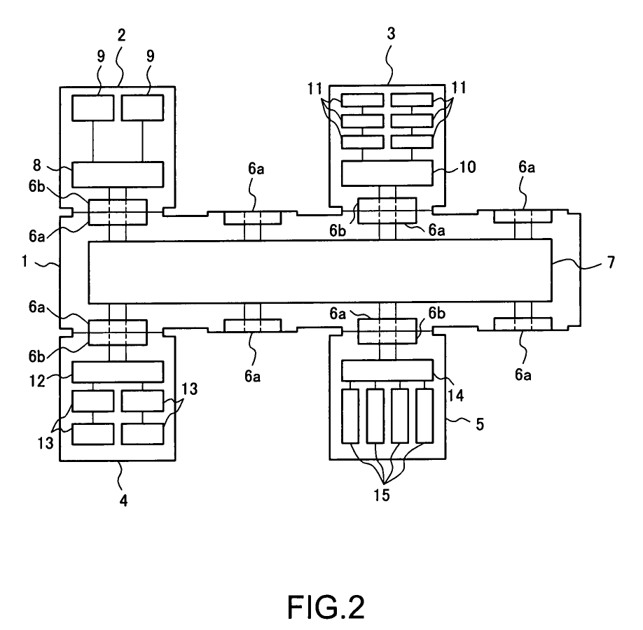

As shown in FIG. 2, only the minimum required devices to execute typical information processing may be provided to the information processing apparatus. One board 2, one board 3, one board 4 and one board 5 are connected to a main board 1. Four switch side connectors 6a are connected to nothing. If memory boards 3 are connected to all of the four switch side connectors 6a that are currently connected to nothing, the total number of the connected memory boards 3 is five.

If any of the currently-connected other type of devices, for example, the CPU board 2 is removed in the case of five memory boards 3 and another memory board 3 is connected to the main board 1 instead of the removed device, then the typical information processing cannot be executed in the information processing apparatus. In other words, the number of memory boards 3 that can be connected to the main board 1 is from one to five. The numbers of the other type of devices that can be connected to the main board 1 are also from one to five.

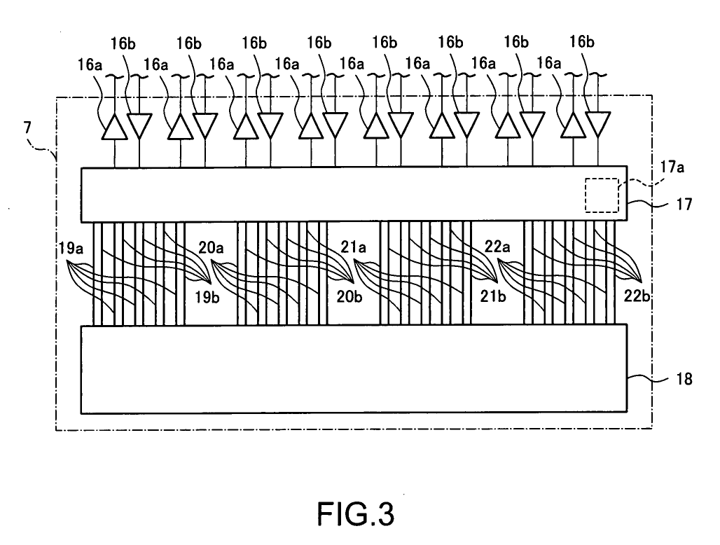

As shown in FIG. 3, the main controller 7 includes a switch 17. The switch 17 is connected to each switch side connector 6a with a pair of lines. One of the lines included in each pair is provided with a driver circuit 16a. Through the line, information is transmitted from the switch 17 to the switch side connector 6a. The other line is provided with a receiver circuit 16b. Through the line, information is transmitted from the switch side connector 6a to the switch 17.

The switch 17 is connected to a controller 18 through plural sets of lines. The controller 18 controls the switch 17 and the devices. One set of lines is provided for each type of device-mounted boards. In the exemplary embodiment, four types of devices are provided, and thus the switch 17 is connected to the controller 18 through four sets of lines. Specifically, lines 19a and 19b are provided for the CPU boards 2, lines 20a and 20b are provided for the memory boards 3, lines 21a and 21b are provided for the HDD boards 4, and lines 22a and 22b are provided for the PCI boards 5.

Each set includes plural pairs of lines. One of the two lines included in each pair, that is, the line 19a, 20a, 21a, or 22a is used for transmitting information from the switch 17 to the controller 18. The other line, that is, the line 19b, 20b, 21b or 22b is used for transmitting information from the controller 18 to the switch 17. In a case where one CPU board 2, one memory board 3, one HDD board 4 and one PCI board 5 are connected to a main board 1 as shown in FIG. 2, information being passed to and from the CPU board 2 is transmitted through one pair of lines 19a and 19b; information being passed to and from the memory board 3 is transmitted through one pair of lines 20a and 20b; information being passed to and from the HDD board 4 is transmitted through one pair of lines 21a and 21b; and information being passed to and from the PCI board 5 is transmitted through one pair of lines 22a and 22b. In a case of FIG. 1, two pairs of lines 19a and 19b, two pairs of lines 20a and 20b, two pairs of lines 21a and 21b, and two pairs of lines 22a and 22b are used. Information transmitted between the controller 18 and the switch 17 is exchanged in the switch 17, and then is passed to each device.

As described above, the maximum number of CPU boards 2 that can be connected to the main board 1 is five. In this way, the maximum number of device-mounted boards that can be connected to the main board 1 is determined for each type of devices. With respect to a certain type of device, the number of pairs included in one set of lines (see FIG. 3) provided for this type is equal to the maximum number of device-mounted boards of this type that can be connected to the main board 1. In the exemplary embodiment, five pairs of lines 19a and 19b are provided for CPU boards 2.

The switch 17 has a built-in identification processor 17a which identifies the type of each board connected to the main board 1, that is, the type of each device connected to the switch 17.

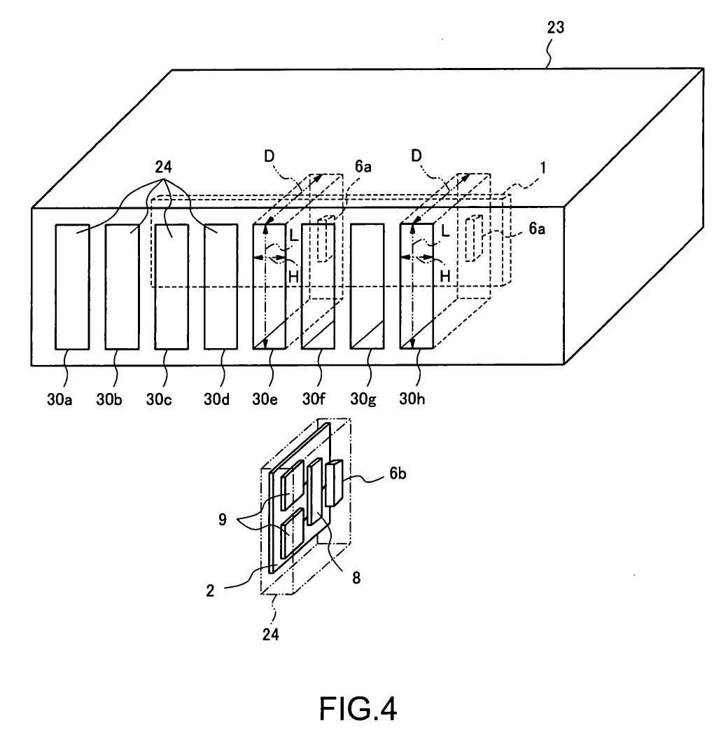

As shown in FIG. 4, the main body includes a chassis 23 in which the main board 1 is incorporated. A plurality of slots are provided to the chassis 23. FIG. 4 shows eight slots 30a, 30b, 30c, 30d, 30e, 30f, 30g and 30h. Each of the slots is provided with one switch side connector 6a. The information processing apparatus includes bases each of which at least one device selected from the device group is mounted on. The bases are formed of the respective device-mounted boards. Each of device-mounted boards is covered with a cover 24. FIG. 4 shows a board 2 as a representative of the device-mounted boards. The slots 30a to 30h have the same dimensions. Each of the device-mounted boards can be housed in any one of the slots 30a to 30h. FIG. 4 shows the dimensions of the slots 30e and 30h. The two slots have the same width H, length L and depth D. When each of device-mounted boards is housed in any one of the slots 30a to 30h, the switch side connector 6a and the device side connector 6b can be connected.

When power is supplied to the information processing apparatus, the identification processor 17a in the switch 17 included in the main controller 7 identifies the type of each board connected to the main board 1. Then, the identification result is passed to the controller 18. As described above, the lines 19a, 19b, 20a, 20b, 21a, 21b, 22a and 22b, which are used for transmission of information between the controller 18 and the switch 17, are divided into groups of the respective device-mounted board types. The controller 18 controls the switch 17 based on the identification result so that information can be transmitted between the board whose type is identified and the lines provided for the board. When the boards are connected to the main board 1 as shown in FIG. 1, the controller 18 controls the switch 17 so that information can be transmitted between each of the two CPU boards and each of two pairs of lines 19a and 19b. The controller 18 also controls the switch 17 so that information can be properly transmitted between each of the other boards and each of the other lines.

Accordingly, the controller 18 passes information from and to all of the boards connected to the main board 1. In other words, information can be transmitted through the controller 18 between any one of the boards and another board, and the controller 18 controls the transmission of information. Even when the type and number of boards connected to the main board 1 are changed, information can be transmitted between any one of the boards and another board, which are connected to the main board 1. Thus, it is possible to freely change the type and number of devices that can be connected to the main board 1.

This application is based upon and claims the benefit of priority from the prior Japanese Patent Application No. 2006-057103, filed Mar. 3, 2006, the entire contents of which are incorporated herein by reference.

Additional advantages and modifications will readily occur to those skilled in the art. Therefore, the invention in its broader aspects is not limited to the specific details shown and described herein. Accordingly, various modifications may be made without departing from the spirit or scope of the general invention concept as defined by the appended claims and their equivalents.

What is claimed is:

1. An information processing apparatus comprising:
a device group including a device which processes information and a device which stores information; and
a switch which is connectable to a plurality of devices selected from the device group, and which allows information to be exchanged between devices connected to the switch.

2. The information processing apparatus according to claim 1, wherein the device group includes a central processing unit, a random access memory and a hard disk drive.

3. The information processing apparatus according to claim 1, comprising:
a plurality of switch side interfaces connected to the switch; and
a plurality of device side interfaces which are respectively connected to devices included in the device group, and each of which is connectable to any one of the switch side interfaces.

4. The information processing apparatus according to claim 3, wherein
each of the switch side interfaces includes a switch side connector,
each of the device side interfaces includes a device side connector, and
each of the device side connectors is connectable to any one of the switch side connectors.

5. The information processing apparatus according to claim 1, further comprising:
bases each of which at least one device selected from the device group is mounted on;
a chassis which houses the switch; and
a plurality of slots provided to the chassis, wherein
each of the bases can be housed in any one of the slots.

6. The information processing apparatus according to claim 5, wherein the slots have the same dimensions.
